(19) United States
(12) Patent Application Publication
(10) Pub. No.: US 2006/0143717 A1
(43) Pub. Date: Jun. 29, 2006

(54) Computer network monitoring method and device

(76) Inventors: Steve Kenneth Ransome, New South Wales (AU); Kelly Jennifer Powell, New South Wales (AU)

Correspondence Address: BROOKS KUSHMAN P.C., 1000 TOWN CENTER, TWENTY-SECOND FLOOR, SOUTHFIELD, MI, 48075, US

(21) Appl. No.: 10/534,103

(22) PCT Filed: Nov. 6, 2003
(86) PCT No.: PCT/AU03/01460

§ 371 Date: May 6, 2005

(30) Foreign Application Priority Data
Nov. 6, 2002 (AU) 2002952484

(51) Int. Cl. G06F 11/00

(52) U.S. Cl. 726/35

(57) ABSTRACT

The present invention provides a system for monitoring at least one computing hardware device located on a computer network. The system includes a testing means in communication with the computer network and arranged to send a first query message to query the status of the at least one computing device, and a second query message specific to the at least one computing device. If one of the first and second query message is not responded to by the computing device, the testing means registers an alarm condition.

### FIELD OF THE INVENTION

The present invention broadly relates to a device and method for monitoring computers and other hardware devices on a computer network.

### BACKGROUND OF THE INVENTION

The theft of computer devices is an increasing problem. In particular, expensive and portable devices such as laptop or palmtop computers are particularly attractive targets to thieves, as they are portable, easy to conceal, valuable, and difficult to secure. In addition, many network devices, such as routers, switches, and small rack mounted servers are also small in size, portable, valuable, and therefore susceptible to theft.

Traditional methods for securing computing devices involve physically attaching the computer device to a fixed desk or other fixed object. Such devices are not aesthetically pleasing, are difficult to operate and, in addition, require a user to be diligent in securing their device each time they leave the device unattended.

In addition to the theft of devices, the theft of data located on devices is also an increasing problem. Computer systems traditionally contain a number of devices to prevent data theft, such as authentication and login processes, encryption of data, etc. While such devices prevent easy access to the data located on a computer, they rely on the assumption that a person wishing to illegally access data must attempt to access the data in a defined period of time. That is, the longer the time required to break the encryption or authentication protocols, the greater the chance the person will be detected. As such, many thieves have realised that it is easier to physically steal a device and then attempt to access the data at a private location where time constraints are no longer an issue.

### SUMMARY OF THE INVENTION

In a first aspect, the present invention provides a system for monitoring at least one computing hardware device located on a computer network, comprising,
testing means in communication with the computer network and arranged to send a generic first query message to query the status of the at least one computing device, and a second query message specific to the at least one computing device,
wherein, if one of the first and second query message is not responded to, the testing means registers an alarm condition.

In a second aspect, the present invention provides a hardware device arranged for monitoring a plurality of computing systems interconnected on a computer network, the device comprising,
means for sending a query message to each of the plurality of computing systems,
means for receiving a reply message from each of the plurality of computing systems,
wherein, if a reply message is not received within a defined period of time, the hardware device registers an alarm condition.

In a third aspect, the present invention provides a method for detecting the absence of at least one of a plurality of computing systems interconnected on a computer network, the method comprising the steps of,
sending a first query message to at least one of the plurality of computing systems,
receiving a first reply message from the at least one of the plurality of computing systems,
sending a second query message in a format only recognisable by the at least one of the plurality of computing systems,
receiving a second reply message in a format only recognisable by the at least one of the plurality of computing systems,
wherein, if the second reply message is not received within a predetermined period of time, an alarm condition is raised by the hardware device.

In a fourth aspect, the present invention provides a method for detecting the absence of at least one of a plurality of computing systems interconnected on a computer network, the method comprising the steps of,
sending a first query message to at least one of the plurality of computing systems,
receiving a first reply message from the at least one of the plurality of computing systems, and, if no first reply message is received within a predetermined period of time,
sending a second query message to an agent responsible for the at least one of the plurality of computing systems,
receiving a second reply message from the agent responsible for the at least one of the plurality of computing systems,
wherein, if the second reply message is not received within a predetermined period of time, an alarm condition is raised by the hardware device.

In a fifth aspect, the present invention provides a method for determining the absence of at least one computing device on a computing network, comprising the steps of,
sending a first query message via the computing network to the at least one computing device,
awaiting receipt of a reply message from the at least one computing device,
wherein, if the reply message is not received within a predetermined period of time, a second query message is delivered via an alternative network to an agent associated with the computing device, and
if the second query message is not responded to within a predetermined period of time, an alarm condition is raised.

In one embodiment, the method comprises the further step of receiving a query message from a software application residing on the computing device.

In an sixth aspect, the present invention provides an apparatus for monitoring at least one computing device located on a computer network, comprising testing means in communication with the computer network and arranged to determine whether the at least one computing device is connected to the computing network, and, if the testing means determines that the at least one computing device is not connected to the network, the testing means is arranged to send a message to an agent associated with the computing device, requesting a return authorisation message to indicate that the at least one computing device is authorised to be disconnected from the network.

In a seventh aspect, the present invention provides a computer program arranged, when loaded on a computing system, to implement the method in accordance with a fifth or sixth aspect of the invention.

In an eighth aspect, the present invention provides a computer readable medium providing a computer program in accordance with a seventh aspect of the invention.

### DETAILED DESCRIPTION OF THE DRAWINGS

Further features of an embodiment of the present invention will now be described, by way of example only, with reference to the following figures in which:

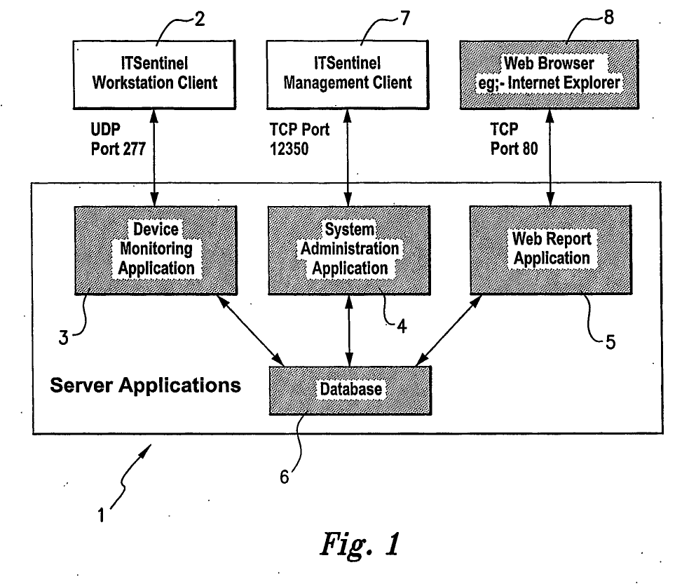

FIG. 1 is a block diagram depicting the application components of a system in accordance with an embodiment of the present invention;

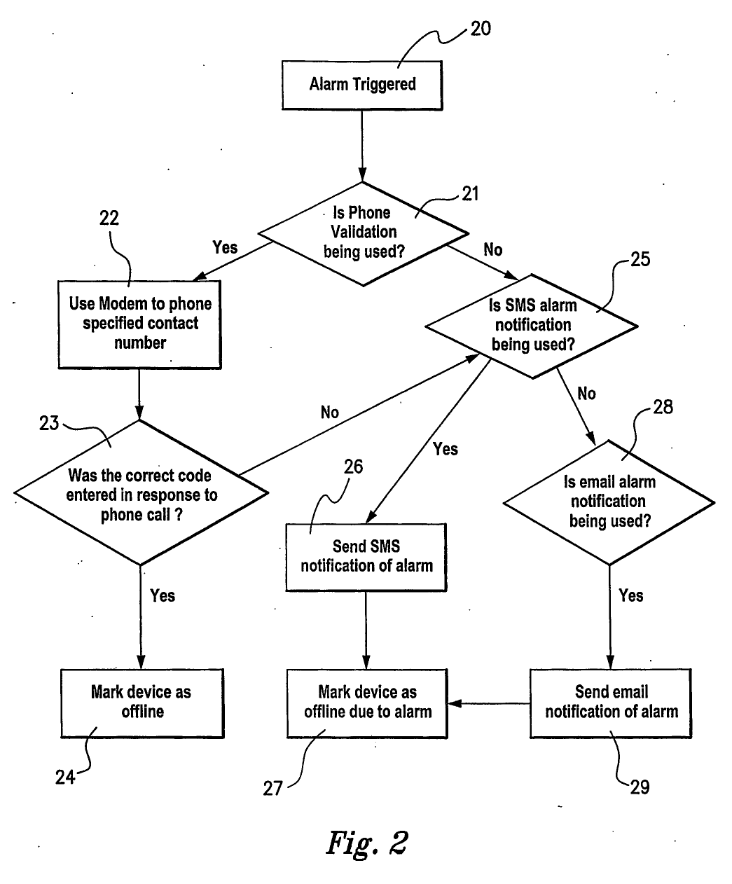

FIG. 2 is a flow chart depicting the alarm action taken by a system in accordance with an embodiment of the present invention; and

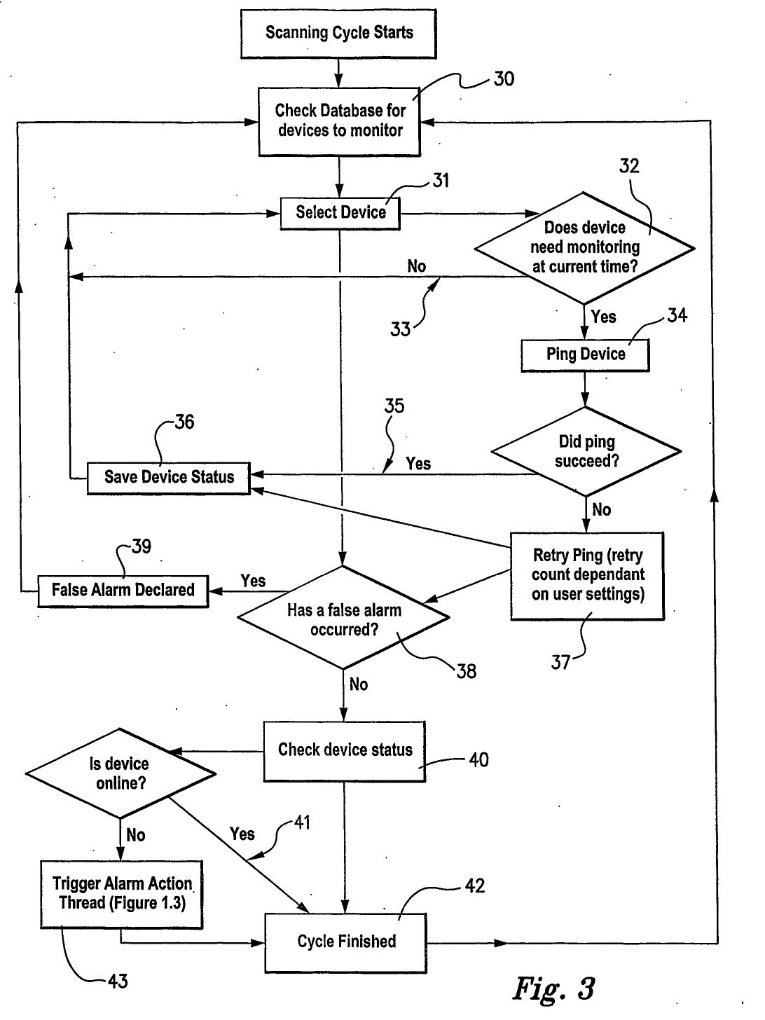

FIG. 3 is a flow chart depicting a device scanning cycle by a system in accordance with an embodiment of the present invention.

### DESCRIPTION OF A SPECIFIC EMBODIMENT

Referring to FIG. 1, there is shown a block diagram depicting a system in accordance with an embodiment of the present invention. There is shown an apparatus 1 which is in communication (via a computer network) with at least one device on a network 2. The device on a network 2 may be a computing device, a router, a switch, a server, a laptop or desktop computer, a personal digital assistant (PDA) or any other device capable of interfacing with a network.

The apparatus 1 is arranged to execute a number of software applications. The applications can include a device monitoring application 3, a system administration application 4, a web report application 5, and an associated database 6 which communicates with the aforementioned software applications. The apparatus 1 may be a hardware device which can be connected to the computer network.

There are also included two interface applications, through which an operator or a user can interface with the apparatus 1. This includes a management client 7 which allows an operator to set up the hardware device 1. The apparatus may also be accessed via a web browser 8 to access the web report application 5. It will be understood that hereafter, a reference to an “apparatus” should be taken to mean a device in accordance with an embodiment of the present invention, and a “machine” should be taken to mean a computing device residing on a computing network.

In one embodiment, the applications are written in C++ and are designed and compiled to be executable on a linux operating system. The linux kernel is appropriately modified so that it may reside on a flash card and interface with a proprietary hardware device. However, it will be appreciated that the linux kernel may reside on any appropriate storage device. For example, in critical applications, a RAID (multi-disk) array may be ustilised.

The apparatus may be a proprietary hardware device whose primary function is to act as a network monitor. However, it will be appreciated that the apparatus is merely a vehicle via which software is executed, and other embodiments of the invention may take the form of a software application arranged to be executed on a conventional computing system, such as an IBM-compatible personal computer, a server, or any other computing device. Such variations are within the purview of a person skilled in the art. In one embodiment, the apparatus is a terminal arranged to run thin client software.

As the apparatus is arranged to monitor the security of a network, the linux kernel utilises an encrypted file system and the proprietary apparatus operates without the use of traditional input devices, such as a keyboard and/or a mouse. Furthermore, the linux kernel is appropriately modified so as to limit the number of “open” ports, and to disable responses to common attacks, such as “ping” attacks.

While a mouse is not utilised in normal operation, the apparatus may have a mouse and keyboard interface, such that a mouse may be used to perform certain functions, such as resetting the apparatus, or refreshing the database.

In order to avoid the production of clone machines, the linux kernel may be designed to operate only on a specified range of MAC addresses and CPU types. That is, the linux kernel may be configured to only boot up if the CPU ID matches the ID expected by the kernel. Other security measures may also be introduced to prevent the cloning of machines, and such variations are within the purview of a person skilled in the art.

Furthermore, the device drivers may be modified to prevent unauthorised access to the device. Such modifications are known in the art and are within the purview of a person skilled in the art.

Each of the three aforementioned applications interact with the database. In one embodiment, the web reporting application only provides read access to the database, to prevent unauthorised or inadvertent deletion of data.

The device monitoring application monitors machines on a computing network, such as a Local Area Network (LAN) or over the Internet, by issuing a ping packet. A ping packet is a query message sent to a specified machine, requesting the status of the machine. Generally, if a machine is online (i.e. successfully connected to the network), a reply message will be returned from the machine to the device monitoring application.

It will be understood that other methodologies may also be employed to contact a machine on the network. For example, if the machine has “gone to sleep” (i.e. is in a low power suspended mode to conserve energy), it is possible to utilise pinging at layer 2 of the OSI (Open Systems Interconnection) model (i.e. a standard for communication between computers residing on a network). This allows the apparatus to continue to monitor machines that have partly shut down communication and or processor utilisation, and thereby reduce the possibility of false alarms.

If no reply is received by the device monitoring application within a predetermined time, the device monitoring application may send further ping requests, as there may be a temporary problem with the network. The number of ping requests is configurable and may be varied by an operator depending on their knowledge of the network. For example, if the network is reliable, then the operator may setup the apparatus so that only 2-3 ping requests may be sent before the apparatus determines that the machine may be offline. Alternatively, if the network is unreliable, the operator may setup the apparatus so that a large number of ping requests are sent before the system determines that the machine may be offline.

If no replies are received to the further ping requests, the apparatus will attempt to verify the status of the machine by other means.

In one embodiment, the second query message may be sent via an alternate network, such as a telephone network, to contact a pre-specified agent to request an appropriate identifier. The purpose of this step is to verify that the disconnection of the machine from the network is not accidental. The agent may be a computer user, or another hardware device. The identifier sought from the agent may be an encrypted packet of information, a personal identification number (PIN), or any other suitable and secure identifier.

In one embodiment, the application monitoring device automatically places a telephone call to a person who is responsible for the computer, and asks the person to provide a PIN to verify that the disconnection of the device is not accidental.

Phone validation utilises an external modem and using a series of AT commands to dial a phone number. On connection to the dialled number either a series of DTMF tones is sent or a pre-recorded voice file is played, the method implemented is dependent on the type of modem being used. The listener then enters a PIN through a phone keypad which is validated by the apparatus. If the PIN matches, the alarm is cancelled however if the PIN does not match or the phone call is not answered an alarm will be raised. The alarm may take any form, including notifying an appropriate security contact such as a security guard or the police. The alarm notification may be sent via telephone, SMS, email, a pop-up message on a terminal, or any other appropriate means. For example, the apparatus may establish a TCP/IP link to an SMS gateway to raise an alarm via SMS (which may be useful if security guards are not near a fixed phone line).

A flow chart depicting an example of the procedure utilised when an alarm condition is triggered is shown in FIG. 2.

When an alarm is triggered (20), the apparatus determines whether telephone validation is being used (21). If phone validation is being used, then the apparatus accesses a modem to phone a pre-programmed telephone number in order to contact an agent or contact person associated with the particular machine (22). The phone call will request the agent or contact person to enter a PIN. Once the agent or contact person has entered the PIN, the system will verify the correctness of the PIN entered (23). If the PIN is correct, the apparatus will mark the machine as offline, and no alarm will be raised (24).

If the PIN entered is incorrect, then the apparatus will check to determine whether SMS (short message service on a GSM network) notification is being utilised (25). If SMS notification is being utilised, then the system will, send an SMS notification of the alarm to the appropriate security contact (26) and the machine will be marked as offline due to the alarm condition (27). Alternatively, if SMS notification is not being utilised, the apparatus will determine whether email notification is being utilised (28). If so, then the apparatus will send an email notification of the alarm to the appropriate security contact (29) and the machine will be marked as offline due to the alarm condition (27).

To provide the device monitoring application with more detailed information, for reporting purposes, the machines may run a workstation client application.

Machines running the workstation client application are referred to as managed devices, those machines not running the workstation client are referred to as unmanaged devices.

The device monitoring application will automatically distinguish between managed and unmanaged machines by sending out a regular “heartbeat request” to the broadcast address using a UDP port connection. All managed machines will receive the heartbeat request and respond with a data packet that confirms their presence on the network and their status in regards to being logged in or logged out of the workstation client application. Machines that are logged out from the workstation client application will not trigger an alarm if removed from the network.

In an alternate embodiment, the workstation client application may automatically send a data packet updating the machine's status to the apparatus without the need for prompting via a heartbeat request.

For unmanaged devices, the only requirement is that the IP address of the machine is within the device scanning range as set by users through the management client. The device monitoring application will ping the device scanning range at regular intervals and any machines responding to the ping will be added to the list of machines to monitor.

The device monitoring application relies on device categories which are used to group both managed and unmanaged machines in accordance with their security requirements. The device categories may be configured by an operator through the management client. However, by default, the following 4 categories are used:

Reception—Devices in the reception area

Server Room—Devices in the server room

Call Centre—Devices in the call centre

Store Room—Devices in the store room

The monitoring of machines and actions taken on alarm are controlled by algorithms as specified by an operator through the management client application. The algorithms are specific to particular device categories and the following parameters (amongst others) may be varied to suit particular conditions and requirements:

Frequency of device monitoring

Action to take on alarm

Contact details for alarm notification

The algorithms are implemented according to a schedule of times set by users through the management client application. The schedule indicates the days and times that particular algorithms are implemented and to which device category the setting applies.

The purpose of the System Administration Application is to provide an interface to view, modify, add and delete system settings. This is achieved by exchange of data packets over a TCP connection between the System Administration Application and the Management Client application.

The types of settings made accessible by the System Administration Application are:
Network Configuration—Setup of the network configuration
Device Categories
Device Scanning Parameters
Algorithm Settings
User Management—Controls user access to the Management Client and Web Reports

The System Administration Application also provides information enabling the operator to view changes in the network status of monitored machines as they occur.

A web server designed specifically for the system operates on port 80 to provide HTML reports, giving users information and graphical representations of data. Reports cover the following areas:

Network Performance Analysis

Hardware Details

Hardware Changes

Memory Usage

Monitoring Status

All reports can be filtered to provide information on specific machines or device categories, and where relevant, reports can also be filtered by date and time.

The HTML reports also show the ping response time and packet loss for each machine over a selected period of time. This may be used by an operator to identify systemic network or machine faults, or to monitor suspicious behaviour. The information saved in the database may also be utilised to monitor machines that have not been logged in for a long time. The reports may be automatically produced and sent to an operator, or they may be manually requested by the operator. Such variations are within the purview of a person skilled in the art.

In one embodiment, the workstation client application is a Windows™ application that can operate on any machine running Windows™ 95, 98, 2000 and Windows XP™. However, it will be understood that the workstation client application may be written for any computing platform or operating system, and such variations are within the purview of a person skilled in the art.

The purpose of the workstation client is to provide hardware and configuration details of the workstation for use by the applications in reporting and device monitoring parameters. Specific information provided by the Workstation Client covers the following areas:

CPU

Physical and virtual memory settings

Motherboard Information

Network Card

Video Card

Services and processes running on the device

Hard Drive/s

The Workstation Client also has a user interface which allows users to log out from the Device Monitoring Application. This requires the user to enter their logout password which is stored in the server side database.

Following a successful log out the machine will not be monitored until the user logs back in. For users who have standby mode enabled the Workstation Client will automatically notify the Device Monitoring Application of this change in status before standby mode is entered.

Communication between the Workstation Client and Device Monitoring Application is via a UDP connection that allows two way exchange of data packets. All data packets exchanged between the Workstation Client and Device Monitoring Application are encrypted to ensure the information remains secure.

The information from the workstation client may be provided as the result of an enquiry by the device monitoring application or by the workstation client on its own initiative—either periodically or when the machine is turned on after being off line for a given time period.

The workstation client may also be arranged to detect if the machine is being shut down or restarted or going into standby or sleep mode and inform the apparatus so that the apparatus can take this factor into account when determining the validity of a potential alarm.

The management client is a Windows™ application that is used to view the status of machines being monitored by the apparatus and to configure settings for the apparatus. The application communicates directly with the system administration application by establishing a TCP connection to the apparatus. All data packets exchanged are encrypted to ensure secure communication.

An example of the working of an embodiment of the present invention will now be described, with reference to FIG. 3.

The apparatus iterates though a scanning cycle for each device it is required to monitor. When the apparatus is first initialised, it checks a database (30) to determine the machines on the network that require monitoring. A machine is selected (31) and the apparatus checks to determine whether the machine requires monitoring (32). If monitoring is not required, the next machine in the database is selected (33). If monitoring is required, then the machine is “pinged” (i.e. a packet of information is sent to the device, the packet being a request to the machine to verify that the machine is connected to the network) (34).

If a reply to the ping is received (35), the status of the machine and the ping response is saved (36), and the next device is selected (31). If the ping was not successful, the ping message is resent (37). If the resent ping is successful, a false alarm is declared (38 and 39) and the system returns to the initial stage of checking the database for machines to monitor (30). If the ping is not successful, the second stage check is initiated (i.e. a phone call is placed, or an SMS sent to an agent to verify that the device has purposely been removed) (40).

If the agent successfully responds to the status check (41), then the cycle is complete and the system returns to checking the database for the next device to monitor (42). If the agent does not successfully respond to the status check, then an alarm condition is triggered (43), as per FIG. 2. An apparatus in accordance with at least an embodiment of the present invention allows all computers on a network, whether the network be a local area network or a wide area network, to be monitored by a central contact, such as a system adminstrator.

In particular, the apparatus allows for constant monitoring of computer resources, such that any suspicious activity may be immediately identified.

In addition, security is provided without the need for any overt action on the part of the end user.

At least an embodiment of an apparatus in accordance with the present invention provides a number of advantages.

Firstly, the apparatus utilises known protocols to communicate with other machines on a computer network. No modification of the computer network is required to integrate the apparatus into an existing network.

Secondly, the apparatus may exchange encrypted packets of information, to reduce the possibility of theft through substitution.

Thirdly, multiple instances of the apparatus may be utilised on a particular network, so that disablement of one apparatus does not threaten the security of the network as a whole. In addition, data may be aggregated from multiple instances of the apparatus to a central server, so that several networks may be compared, or so that deficiencies in one network may be identified. As a corollary, the data collected by the apparatus may be used to analyse network performance or deficiencies, security issues, poor practices or suspicious behaviour.

Fourthly, the configurable nature of the apparatus allows an operator to plan ahead and disable the monitoring of certain machines on a network whilst not threatening the security of the network as a whole.

Fifthly, the apparatus shifts the responsibility for monitoring computer systems away from the end user. The end user merely needs to attach their machine (laptop or other computing device) to the network, and all monitoring is performed remotely and without any overt security measures. The user is not required to concern themselves with physical locks, security devices, etc. Furthermore, if an end user inadvertently removes their machine from the network, the network administrator can verify the removal of the machine easily by contacting the user to verify that the removal is authorised.

Modifications and variations as would be apparent to a person skilled in the art are within the scope of the present invention.

1. A system for monitoring at least one computing hardware device located on a computer network, comprising,
a testing means in communication with the computer network and arranged to send a first query message to query the status of the at least one computing device, and a second query message specific to the at least one computing device,
wherein, if one of the first and second query message is not responded to by the computing device, the testing means registers an alarm condition.

2. A hardware device arranged for monitoring a plurality of computing systems interconnected on a computer network, the device comprising,
means for sending a query message to each of the plurality of computing systems,
means for receiving a reply message from each of the plurality of computing systems,
wherein, if a reply message is not received within a defined period of time, the hardware device registers an alarm condition.

3. A system in accordance with claim 2, further comprising means to send a second query request to at least one of the plurality of computing systems, wherein, if a reply message to the second query request is not received within a defined period of time, the hardware device registers an alarm condition.

4. A system in accordance with claim 3, comprising receiving means for receiving an information message from a software application residing on the computing system, wherein the information message contains information pertaining to the identity of the computing device.

5. A system in accordance with claim 4, wherein the query message is a ping request.

6. A system in accordance with claim 1, wherein the query message is encrypted.

7. A system in accordance with claim 6, wherein the second query message is sent via the telephone network.

8. A system in accordance with claim 6, further comprising requesting means for requesting an authorisation code from an agent.

9. A system in accordance with claim 2, wherein the alarm condition is communicated via a telephone network.

10. A system in accordance with claim 2, wherein the alarm condition is communicated via an email message.

11. A system in accordance with claim 1, further comprising logging means to log the response received to the query message.

12. A method for detecting the absence of at least one of a plurality of computing systems interconnected on a computer network, the method comprising the steps of,
sending a first query message to at least one of the plurality of computing systems,
receiving a first reply message from the at least one of the plurality of computing systems,
sending a second query message in a format only recognisable by the at least one of the plurality of computing systems,
receiving a second reply message in a format only recognisable by the at least one of the plurality of computing systems,
wherein, if the second reply message is not received within a predetermined period of time, an alarm condition is raised by the hardware device.

13. A method for detecting the absence of at least one of a plurality of computing systems interconnected on a computer network, the method comprising the steps of,
sending a first query message to at least one of the plurality of computing systems,
receiving a first reply message from the at least one of the plurality of computing systems, and, if no first reply message is received within a predetermined period of time,
sending a second query message to an agent responsible for the at least one of the plurality of computing systems,
receiving a second reply message from the agent responsible for the at least one of the plurality of computing systems,
wherein, if the second reply message is not received within a predetermined period of time, an alarm condition is raised by the hardware device.

14. A method for determining the absence of at least one computing device on a computing network, comprising the steps of,
sending a first query message via the computing network to the at least one computing device,
awaiting receipt of a reply message from the at least one computing device,
wherein, if the reply message is not received within a predetermined period of time, a second query message is delivered via an alternative network to an agent associated with the computing device, and
if the second query message is not responded to within a predetermined period of time, an alarm condition is raised.

15. A method in accordance with claim 14, comprising the further step of receiving an information message from a software application residing on the computing device, whereby the information message contains information pertaining to the identity of the computing device.

16. A method in accordance with claim 15, whereby the first query message is a ping request.

17. A method in accordance with claim 14, wherein the first query message is encrypted.

18. A method in accordance with claim 17, whereby the second query message is sent via the telephone network.

19. A method in accordance with claim 14, comprising the further step of requesting an authorisation code from an agent.

20. A method in accordance with claim 14, whereby the alarm condition is communicated via a telephone network.

21. A method in accordance with claim 14, whereby the alarm condition is communicated via an email message.

22. A method in accordance with claim 14, comprising the further step of logging each response to the query message.

23. An apparatus for the monitoring at least one computing device located on a computer network, comprising testing means in communication with the computer network and arranged to determine whether the at least one computing device is connected to the computing network, and, if the testing means determines that the at least one computing device is not connected to the computing network, the testing means is arranged to send a message to an agent associated with the computing device, requesting a return authorisation message to indicate that the at least one computing device is authorised to be disconnected from the network.

24. An apparatus in accordance with claim 23, further comprising reporting means arranged to provide historical information on return authorisation messages received by the apparatus.

25. An apparatus in accordance with claim 24 further including configuration means arranged to vary the frequency at which the testing means determines whether the at least one computing device is connected to the computing network.

26. An apparatus in accordance with claim 25, further including receiving means arranged to receive information from the at least one computing device, the information including information regarding the status and configuration of at least one computing device.

27. A computer program arranged, when loaded on a computing system, to implement the method of claim 12.

28. A computer readable medium providing a computer program in accordance with claim 27.
